(19) United States
(12) Patent Application Publication
(10) Pub. No.: US 2018/0359943 A1
(43) Pub. Date: Dec. 20, 2018

(54) SYSTEM AND METHOD FOR CARBON DIOXIDE CAPTURE AND DISTRIBUTION FOR INDOOR AGRICULTURE

(71) Applicant: Smart Grow Pros, LLC, Denver, CO (US)

(72) Inventor: Jody Vukas, Denver, CO (US)

(21) Appl. No.: 16/009,991

(22) Filed: Jun. 15, 2018

Related U.S. Application Data
(60) Provisional application No. 62/520,752, filed on Jun. 16, 2017.

(51) Int. Cl. A01G 9/18; A01G 9/24; A01G 9/26; G08B 17/117

(52) U.S. Cl. CPC A01G 9/18; G08B 17/117; A01G 9/26; A01G 9/246

(57) ABSTRACT

Systems, devices, and methods including: a fresh air damper configured to receive outside air via an input plenum; a mixing chamber configured to receive the outside air from the fresh air damper and exhaust from one or more chillers, where the outside air and the exhaust are mixed in the mixing chamber; a blower section comprising a blower, where the blower section is configured to receive mixed air from the mixing chamber, and where the mixed air from the mixing chamber is received through a mixing damper; and a relief damper connected to at least one of: the mixing chamber and the blower section via a relief ducting, where the relief damper allows a release of at least one of: the fresh air, the exhaust, and the mixed air to an ambient environment

### CROSS-REFERENCE TO RELATED APPLICATIONS

This application claims priority to and the benefit of U.S. Provisional Patent Application No. 62/520,752, filed Jun. 16, 2017, the contents of which are hereby incorporated by reference herein for all purposes.

### TECHNICAL FIELD

Embodiments relate generally to indoor agriculture, and more particularly to indoor agriculture controls.

### BACKGROUND

Demand for indoor agriculture is continually increasing as technology advances. Lighting systems continue to develop that are tailored to provide ideal operating situations for growing specific plants. Growers can specifically tailor the lighting conditions to control yields from their plants.

### SUMMARY

A system embodiment may include: a fresh air damper configured to receive outside air via an input plenum; a mixing chamber configured to receive the outside air from the fresh air damper and exhaust from one or more chillers, where the outside air and the exhaust are mixed in the mixing chamber; a blower section comprising a blower, where the blower section may be configured to receive mixed air from the mixing chamber, and where the mixed air from the mixing chamber may be received through a mixing damper; and a relief damper connected to at least one of: the mixing chamber and the blower section via a relief ducting, where the relief damper allows a release of at least one of: the fresh air, the exhaust, and the mixed air to an ambient environment.

In additional system embodiments, the exhaust may be received in the mixing chamber via one or more exhaust connections. The mixed air from the mixing chamber may be filtered through a filter. Additional system embodiments may include: a cooling section having a chilled water coil and an internal temperature sensor, where the cooling section may be configured to receive mixed air from the blower section, and where the chilled water coil may be configured to cool the mixed air to a set temperature as recorded by the internal temperature sensor. Additional system embodiments may include: a distribution ducting, where the distribution ducting may be configured to receive at least one of: mixed air from the blower section and a chilled mixed air from the cooling section.

Additional system embodiments may include: one or more room dampers, where the one or more room dampers may be configured to receive a distributed air from the distribution ducting. The system may also include one or more distribution sections, where the one or more distribution sections are configured to receive the distributed air from the distribution ducting through the respective room damper. The system may also include: one or more grow rooms, where the one or more grow rooms may be configured to receive the distributed air from the respective distribution section. Additional system embodiments may include one or more room exhausts, where the one or more room exhausts are configured to vent the distributed air to the ambient environment.

Another system embodiment may include: a controller having a processor with addressable memory, the controller configured to: enable an exhaust condition state, where in the exhaust condition state one or more chillers are operating and there may be no demand for carbon dioxide in any grow room, and where enabling the exhaust condition state comprises generating at least one of: a fresh air damper signal to open a fresh air damper; a damper control signal to close a mixing damper; a relief damper control signal to open a relief air damper; a blower control signal to turn on a blower for at least a set time; a chilled water control signal to close a chilled water coil valve; and a room damper control signal to close each room damper.

In additional system embodiments, the controller may be further configured to: enable a demand condition state, where in the demand condition state the one or more chillers are operating and there may be demand for carbon dioxide in at least one grow room, and where enabling the demand condition state comprises generating at least one of: the fresh air damper signal to open the fresh air damper; the damper control signal to open the mixing damper; the relief damper control signal to close the relief air damper; the blower control signal to turn on the blower; the chilled water control signal to open the chilled water coil valve; and the room damper control signal to open each room damper for each room demanding carbon dioxide.

In additional system embodiments, the controller may be further configured to: enable a demand met condition state, where in the demand met condition state the at least one grow room with the demand for carbon dioxide has had the demand met, where enabling the demand met condition state may include generating at least one of: the room damper control signal to close each room damper for each room having met demand for carbon dioxide; the demand condition state if there are remaining rooms that demand carbon dioxide; and the exhaust condition state if there are no remaining rooms that demand carbon dioxide.

In additional system embodiments, the controller may be further configured to: enable an upset condition state, where in the upset condition state at least one grow room has a carbon dioxide level that may be at least one of: above a predefined threshold, and below a predefined threshold, where enabling the upset condition state comprises generating at least one of: the fresh air damper signal to open the fresh air damper; the damper control signal to open the mixing damper; the relief damper control signal to open the relief air damper; the blower control signal to turn on the blower; the chilled water control signal to close the chilled water coil valve; the room damper control signal to close each room damper; and an exhaust control signal to open at least one exhaust in at least one of: all grow rooms, each grow room having the sensor level above the predefined threshold, and each grow room having the sensor level below the predefined threshold.

In additional system embodiments, enabling the upset condition state may further include the controller generating: a siren control to turn on at least one siren in at least one of: all grow rooms, each grow room having a sensor level above a predefined threshold, and each grow room having a sensor level below a predefined threshold. Enabling the upset condition state may further include the controller generating: a fire monitor output, where the fire monitor output may be sent to a fire panel for relay to a fire department.

In additional system embodiments, the controller may be further configured to: enable a power interruption state, where in the power interruption state at least one of: a power to at least one sensor may be interrupted and a sensor input may be not received by the controller, and where enabling the power interruption state comprises: the fresh air damper signal to open the fresh air damper; the damper control signal to open the mixing damper; the relief damper control signal to open the relief air damper; the blower control signal to turn the blower on; the chilled water control signal to close the chilled water coil valve; and the room damper control signal to close each room damper.

A method embodiment may include: receiving, by a controller having a processor with addressable memory, at least one of: a temperature in a mixing chamber and a carbon dioxide concentration in a mixing chamber; generating, by the controller, a damper control signal to open a mixing damper connected to the mixing chamber when at least one of: the received temperature in the mixing chamber may be within a set temperature range and the received carbon dioxide concentration in the mixing chamber may be within a set carbon dioxide range; generating, by the controller, a blower control signal to turn on a blower, where the blower may be configured to move air from the mixing chamber through one or more distribution ducts; and generating, by the controller, a room damper control signal to open one or more room dampers, where the one or more room dampers control a flow of the air from the one or more distribution ducts to one or more grow rooms.

Additional method embodiments may include: receiving, by the controller, a carbon dioxide concentration of each grow room of the one or more grow rooms; generating, by the controller, the room damper control signal to close at least one of: all room dampers, each room damper for each grow room having the received carbon dioxide concentration above a predefined threshold, and each room damper for each grow room having the received carbon dioxide concentration below the predefined threshold; and generating, by the controller, an exhaust control signal to open at least one exhaust in at least one of: all grow rooms, each grow room having the received carbon dioxide concentration above the predefined threshold, and each grow room having the received carbon dioxide concentration below the predefined threshold.

Additional method embodiments may include: generating, by the controller, a fresh air damper control signal to at least one of: open a fresh air damper and close the fresh air damper, where the fresh air damper provides fresh air to the mixing chamber, and where the mixing chamber receives exhaust from one or more chillers. Additional method embodiments may include: generating, by the controller, a chilled water control signal to at least one of: open a chilled water coil valve and close the chilled water coil valve, where air from the blower travels past a chilled water coil receiving chilled water from the chilled water control valve prior to flowing to the one or more distribution ducts.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1A depicts a system for distributing carbon dioxide (CO₂) into an indoor agriculture facility, in embodiments;

FIG. 1B depicts a functional block diagram of the system of FIG. 1, in embodiments;

FIG. 2 depicts an example block diagram of an indoor agriculture facility utilizing the system of FIG. 1, in embodiments;

FIG. 3 depicts an example method performed by the control logic of FIG. 2, in embodiments;

FIG. 4 depicts an example method for delivering CO₂ into an indoor agriculture facility, in embodiments; and

FIG. 5 illustrates a top-level functional block diagram of a computing device embodiment of a system for distributing CO₂ into an indoor agriculture facility, in embodiments.

### DETAILED DESCRIPTION

The system and method disclosed herein allows for the distribution of carbon dioxide (CO₂) in an indoor agricultural facility. Exhaust containing CO₂ may be mixed with outside air, filtered, and/or chilled to achieve a desired CO₂ concentration and temperature for distributed air. One or more dampers may control the flow of this distributed air to one or more grow rooms. One or more sensors may monitor the CO₂ concentration, temperature, and the like throughout the system. A controller may control the position of each damper, blower, and/or chiller based on a desired state and/or sensor readings. Specific control of the temperature and atmospheric conditions, such as ambient gas levels, may be used to control yields of the plants.

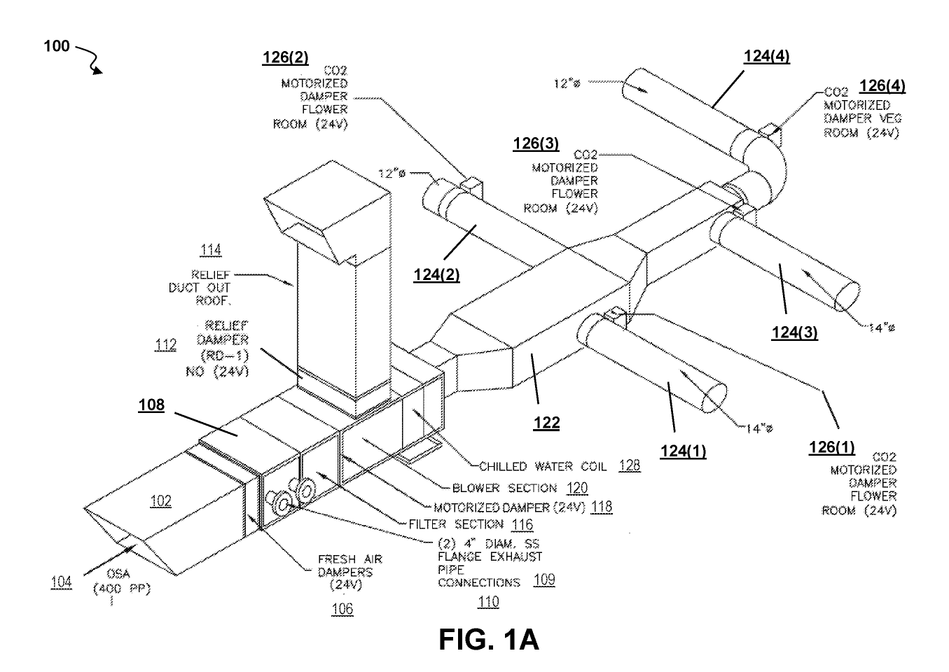

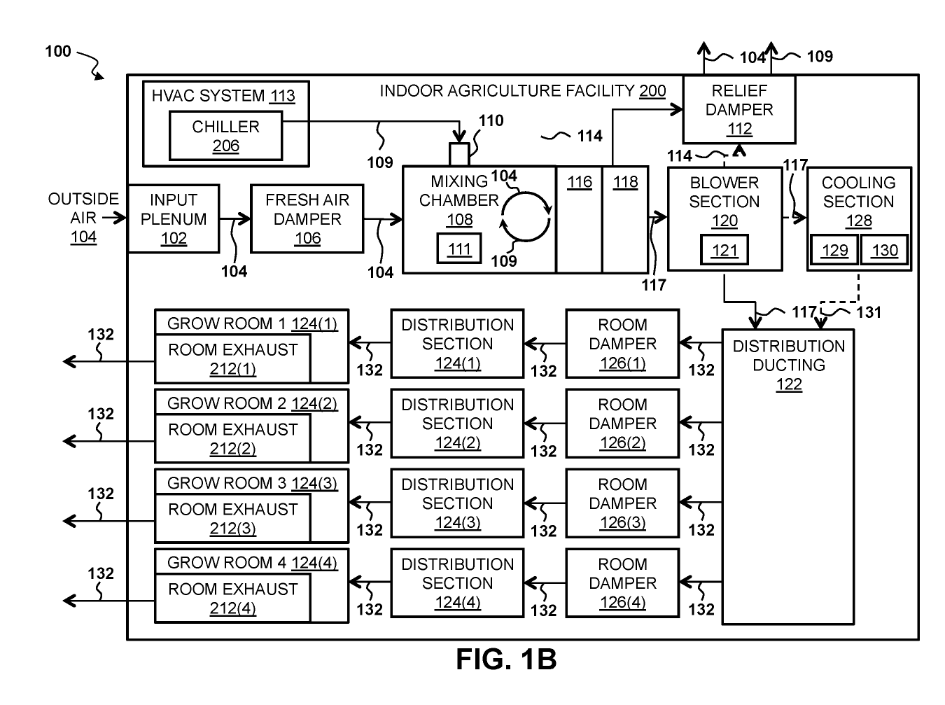

FIG. 1A depicts a system 100 for distributing carbon dioxide (CO₂) into an indoor agriculture facility, in embodiments. The system 100 may be separate from, or integrated with, the facility's air conditioning and/or heating system. The system 100 includes an input plenum 102 that delivers outside air 104 from outside the indoor agriculture facility into system 100. The inflow of air 104 is controlled via a fresh air damper 106 where outside air 104 then enters a mixing chamber 108. Mixing chamber 108 further includes exhaust connections 110. Exhaust connections 110 coupled with one or more chillers 206, as shown in FIG. 1B, which may be part of the indoor agriculture facility's heating, ventilation, and air conditioning (HVAC) system. Exhaust 109 from the chiller enters into mixing chamber 108, where it is combined with outside air 104.

The amount of outside air 104 that is combined with exhaust 109 from the chiller may depend on the desired characteristics of output air from system 100. For example, exhaust 109 may enter mixing chamber 108 at upwards of 500 degrees Fahrenheit. By mixing exhaust 109 with outside air 104, the mixture may have a reduced temperature prior to entering a chilling coil 128. This reduced temperature may minimize potential condensation throughout the system 100 and ensure the desired temperature for delivery into the agriculture facility. Accordingly, mixing chamber 108 may include an internal temperature sensor such that a mixing damper 118 is not opened until the mixed air within mixing chamber 108 reaches the desired temperature.

Additionally, the percentage of fresh air 104 to exhaust 109 is determined based on the desired amount of CO₂ output from system 100. For example, for an exhaust 109 output range of 800-950 cubic feet per minute (CFM), an amount of fresh air 104 may be desirable at 200-400 CFM. In some embodiments, this may result in a CO₂ delivery of 110-120 lbs. per hour. In some embodiments, the exhaust 109 may not be mixed with any outside air 104, e.g., the fresh air damper 106 is closed during operation.

Mixing chamber 108 may further be coupled with one or more of a relief damper 112, which is in turn coupled with relief ducting 114; and a filter 116, in embodiments. Relief damper 112 and relief ducting 114 are configured to allow a release of the air 104, and chiller exhaust from connections 110, out of the mixing chamber 108.

Upon adequate mixing within mixing chamber 108, the mixed air passes through a filter 116 coupled to mixing chamber 108. In embodiments, the filter 116 may be a screen type carbon filter to specifically remove any particulates and help purify the air before it enters the grow rooms. It is appreciated that other types of air filters may be utilized without departing from the scope hereof, such as fiberglass filters, polyester and pleated filters, HEPA filters, etc.

The movement of mixed air from mixing chamber 108 to the filter section 116 may be controlled via a motorized mixing damper 118, which separates the mixed air within filter section 116 from a blower section 120. Blower section 120 may include a blower, e.g., a fan, backward inclined blower, centrifugal blower, cross-flow blower, draft inducer blower, or radial blade blower, and/or any other blower known in the art. Blower section 120 may be configured to move mixed air, e.g., air that has been filtered in filter section 116, from the mixing chamber 108 and distributes said mixed air throughout the indoor agriculture facility.

For example, blower section 120 may move air into distribution ducting 122. Distribution ducting 122 may include one or more distribution sections 124(1)-(4) located in a respective agriculture room (not shown) within agriculture facility. Each respective distribution section 124(1)-(4) may include its own room damper 126(1)-(4) such that CO₂ levels within each grow room may be controlled independently. It should be appreciated that, although four distribution sections 124(1)-(4) are shown, there may be more or few sections 124(1)-(4) without departing from the scope hereof. Each room damper 126(1)-(4) may operate and supply a different room within the indoor agriculture facility. For example, one room damper 126(1) may supply 900 PPM of CO₂ to a vegetative grow phase room, and another room damper 126(2) may supply a higher or lower range, such as 1400-1500 PPM of CO₂ to a flowering grow stage room. Control of room dampers 126(1)-(4) may further be coupled with control of lighting within the indoor agriculture facility such that mixed air from cooling section 128 is pushed into indoor agriculture facility when the grow lighting is switched on, e.g., the plants are undergoing photosynthesis.

In various embodiments, when the indoor agriculture facility reaches the desired characteristic, e.g., a desired CO₂ level, each room damper 126(1)-(4) may be closed, and the relief damper 112 may be opened such that the system 100 pushes all exhaust to the atmosphere, e.g., external the indoor agriculture facility.

In embodiments, prior to distribution ducting 122, there may be a cooling section 128. Cooling section 128 may include a chilled water coil 129, as shown in FIG. 1B, for additional cooling of mixed air from the mixing chamber 108. In embodiments, mixed air output from the cooling section 128 may be reduced in temperature, e.g., at a range of 77-80 degrees Fahrenheit. Accordingly, the cooling section 128 may include an internal temperature sensor 130, as shown in FIG. 1B, such that the room dampers 126(1)-(4) are not opened until the mixed air within cooling section 128 reaches the desired temperature.

In certain embodiments, the chiller(s) coupled to mixing chamber 108 via exhaust connections 110 may be a gas fired water chiller. For example, the chiller may be a Tecogen Gas Fired Water chiller located external to the indoor agriculture facility. The chiller may be powered by a 115 hip Ultra Clean natural gas engine and equipped with secondary catalytic converters. For example, in embodiments, the chiller may have a secondary oxidizing catalytic for the exhaust that removes 99.8% of the carbon dioxide and VO2, which allows for a clean, self-sustainable carbon monoxide solution for indoor agriculture versus liquid CO₂. The chiller(s) may be located external the indoor agriculture facility such that heat produced thereby is dissipated external to the building.

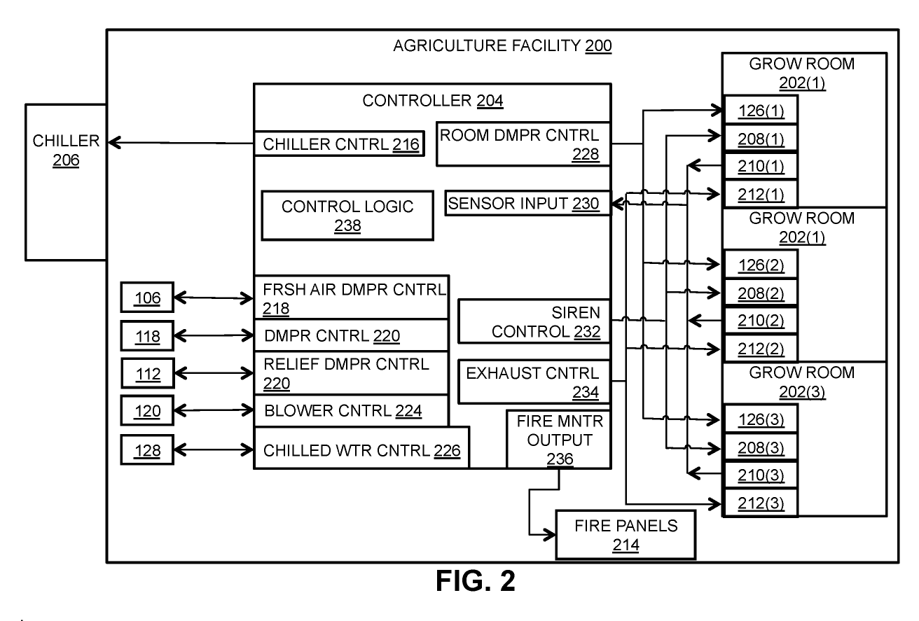

FIG. 1B depicts a functional block diagram of the system 100 of FIG. 1, in embodiments. The indoor agriculture facility 200 may have one or more grow rooms 126(1)-(4) each having different requirements for CO₂, temperature, light, and the like. The system 100 disclosed herein may utilize a controller 204, as shown in FIG. 2, to provide variable CO₂, temperature, light, and the like to each of the one or more grow rooms 126(1)-(4).

The input plenum 102 receives outside air 104 from outside the indoor agriculture facility 200. The outside air 104 proceeds through a fresh air damper 106. The fresh air damper 106 may be motorized and controlled by a controller 204, as shown in FIG. 1B. The fresh air damper 106 may be opened a variable amount to allow a desired amount of outside air 104 to pass through the fresh air damper 106.

Outside air 104 passes through the fresh air damper 106 and into a mixing chamber 106. Exhaust 109 from one or more chillers 206 may also pass into the mixing chamber 106 via one or more exhaust connections 110. In some embodiments, the one or more exhaust connections 110 may include an exhaust damper for varying the amount of exhaust 109 entering into the mixing chamber 106. In some embodiments, the chiller 206 may be a part of the indoor agriculture facility 200 heating, ventilation, and air conditioning (HVAC) system 113. While one or more chillers 206 are depicted, any device that produces a significant amount of CO₂ may be used in the system 100.

The outside air 104 and exhaust 109 may be mixed together in the mixing chamber 106 to achieve a desired mixed air 117 temperature and/or CO₂ concentration. Exhaust 109 may enter mixing chamber 108 at upwards of 500 degrees Fahrenheit, while outside air may be significantly lower, e.g., 75 degrees based on ambient temperature outside of the facility 200. Mixing the outside air 104 and the exhaust 109 lowers the temperature of the mixed air 117. This reduced temperature may minimize potential condensation and ensure a desired temperature for delivery into each grow room 124(1)-(4). In some embodiments, the mixing chamber 106 may include one or more sensors, such as an internal temperature sensor 111. The mixing damper 118 may open once the mixed air 117 in the mixing chamber 106 reaches the desired temperature and/or CO₂ concentration. In some embodiments, the exhaust 109 may not be mixed with any outside air 104 and the fresh air damper 106 may be closed during operation.

Mixed air 117, fresh air 104, and/or exhaust 109 in the mixing chamber 106 may be vented to atmosphere. The relief ducting 114 may allow a release of air from the mixing chamber 106 through a relief damper 112. The relief damper 112 may be opened once each grow room 124(1)-(4) reaches a desired CO2 level, temperature, or the like, and the air remaining in the mixing chamber 106 may be vented to atmosphere. In some embodiments, the relief ducting 114 may allow a release of air from the blower section 120 through the relief damper 112.

Mixed air 117 travels from the mixing chamber 106, through a filter 116, through the mixing damper 118, and into the blower section 120. The blower section 120 includes a blower 121. The blower 121 moves the mixed air 117 that has been filtered in filter section 116 from mixing chamber 108 and distributes said mixed air throughout the indoor agriculture facility 200.

In some embodiments, the air from the blower section 120 moves to a cooling section 128. The cooling section 128 may include one or more coolers, such as a chilled water coil 129, and one or more sensors, such as an internal temperature sensor 130. In some embodiments, chilled mixed air 131 output from cooling section 128 may be at a range of 77-80 degrees Fahrenheit. Room dampers 126(1)-(4) may not be opened until the mixed air 117 within cooling section 128 reaches the desired temperature. The chilled water coil 129 may be turned on or off by the controller 204, as shown in FIG. 2, based on the mixed air 117 temperature, the desired temperature entering each grow room 124(1)-(4), and the like.

Mixed air 117 from the blower section 120 and/or chilled mixed air 131 from the cooling section 128 may enter distribution ducting 122. The distribution ducting 122 may be placed about the indoor agricultural facility 200 to deliver distributed air 132 to each grow room 124(1)-(4). One or more room dampers 126(1)-(4) may be connected to the distribution ducting 122 to control the flow of distributed air 132 from the distribution ducting, through each distribution section 124(1)-124(4) and to each grow room 124(1)-(4). While each room damper 126(1)-(4) is shown as connected to the distribution ducting 122, the room damper 126(1)-(4) may be located in any location so as to control the flow of distributed air 132 to the respective grow rooms 124(1)-(4). In one embodiment, each room damper 126(1)-(4) may be directly connected to the blower section 120 and/or cooling section. In another embodiment, the distribution ducting 122 may be connected to each distribution section 124(1)-(4) with each room damper 126(1)-(4) connected to each grow room 124(1)-(4). Any combination of room damper 126(1)-(4), distribution section 124(1)-(4), and/or distribution ducting 122 may be used so as to control the flow of distributed air 132 to each grow room 124(1)-(4). In some embodiments, one room damper 126(1)-(4) may be used to control the flow of distributed air 132 to one or more grow rooms 124(1)-(4).

Each grow room 124(1)-(4) may include a respective room exhaust 212(1)-(4). The room exhaust 212(1)-(4) may exhaust the distributed air 132 in each grow room 202 to an ambient environment, e.g., outside the facility 200. In one embodiment, the room exhaust 212(1)-(4) may exhaust the distributed air 132 when atmospheric levels sensed by one or more sensors in the grow room 124(1)-(4) are below a given threshold, at a given threshold, or above a given threshold.

FIG. 2 depicts an example block diagram of an indoor agriculture facility 200 utilizing system 100, of FIG. 1A, in embodiments. Additional components shown within FIG. 2 such as the sensors, sirens, exhaust, and fire monitoring system, for example, may be part of system 100 without departing from the scope hereof. Facility 200 is shown with three grow rooms 202(1)-(3), but may have more or fewer without departing from the scope hereof.

A controller 204 processes and generates electrical signals for manipulating the system 100. Controller 204 may receive and/or generate a chiller control signal 216 for controlling the one or more chiller(s) 206. Controller 204 may receive and/or generate a fresh air damper control signal 218 for controlling fresh air damper 106 of FIG. 1A. Controller 204 may receive and/or generate a damper control signal 220 for controlling mixing damper 118 of FIG. 1A. Controller 204 may receive and/or generate a relief damper control signal 222 for controlling relief damper 112 of FIG. 1A. Controller 204 may receive and/or generate a blower control signal 224 for controlling a blower in the blower section 120 of FIG. 1A. Controller 204 may receive and/or generate a chilled water control signal 226 for controlling the chilled water coil of the cooling section 128 of FIG. 1A. Controller 204 may receive and/or generate a room damper control signal 228 for controlling one or more room dampers 126(1)-(4) of FIG. 1A. Controller 204 may receive sensor input 230 from one or more atmospheric sensors 210(1)-(3) located in each of rooms 202(1)-(3), respectively. For example, sensors 210 may sense the amount of CO₂ and/or temperature within a given room 202(1)-(3). Controller 204 may receive and/or generate a siren control signal 232 for controlling one or more room sirens 208(1)-(3). Sirens 208 may operate to alarm any persons present within a given room 202 when atmospheric levels sensed by sensors 210 are below a given threshold or above a given threshold. Controller 204 may receive and/or generate an exhaust control signal 234 for controlling one or more room exhausts 212(1)-(3). Room exhausts 212(1)-(3) may operate to exhaust each grow room 202(1)-(3) to an ambient environment when atmospheric levels sensed by sensors 210(1)-(3) are below a given threshold or above a given threshold. Controller 204 may receive and/or generate a fire alarm signal 236 for controlling one or more fire panels 214 associated with facility 200. Fire panels 214 may be coupled to a local fire department, e.g., via wireless or wired communication channels, to automatically initiate an emergency alarm when signaled by the fire alarm signal 236.

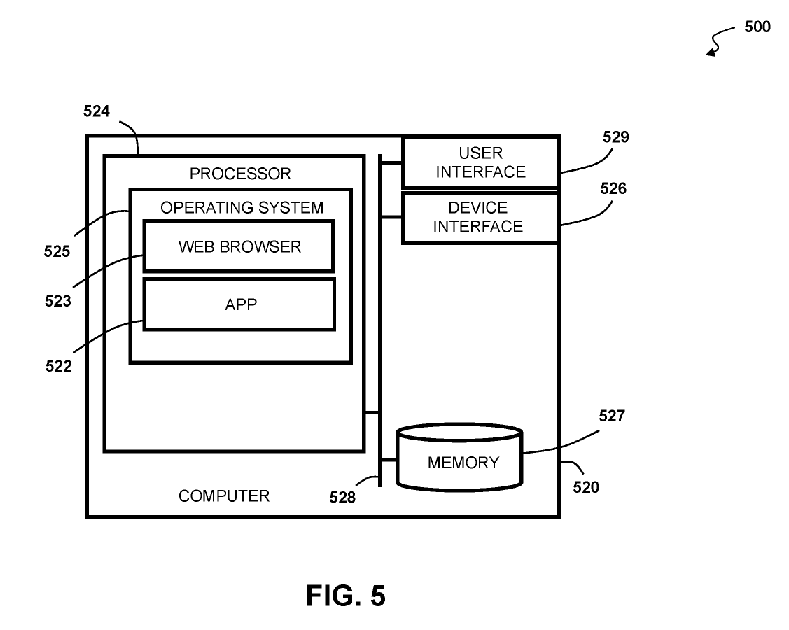

Signals to and from controller 204, such as those discussed above, may be utilized and/or generated based on control logic 238. Control logic 238 may include machine-readable instructions that, when executed by a processor, as shown in FIG. 5, operate to process and/or generate one or more of the signals discussed above.

Control logic 238 may operate based on an exhaust condition state. Under the exhaust condition state, the one or more chiller(s) 206 may be operating, but there may be no demand for CO₂ within any of rooms 202(1)-(3). Therefore, under this exhaust condition state, control logic 238 may generate one or more of: a fresh air damper signal 218 to open fresh air damper 106; a damper control 220 signal such that mixing damper 118 is closed; a relief damper control signal 222 such that relief air damper 112 is open; a blower control signal 224 such that blower 120 is on, and potentially turned off after a given time; a chilled water control signal 226 such that chilled water coil valve 128 is closed; and a room damper control signal 228 such that each room damper 126 is closed.

Control logic 238 may operate based on a demand condition state. Under the demand condition state, the chiller(s) 206 may be operating, and there may be a demand for CO₂ within one or more of rooms 202. Therefore, under this demand condition state, control logic 238 may generate one or more of: a fresh air damper signal 218 to open fresh air damper 106; a damper control 220 signal such that mixing damper 118 is open; a relief damper control signal 222 such that relief air damper 112 is closed; a blower control signal 224 such that blower 120 is on; a chilled water control signal 226 such that a valve coupled with chilled water coil 128 is open thereby chilling air near the chilled water coil 128; and a room damper control signal 228 such that each room damper 126 for the room(s) demanding CO₂ is open.

Control logic 238 may operate based on a demand met condition state when the room 202 previously demanding CO₂ has met its requested demand. The demand met condition state may occur when the room 202 previously demanding CO₂ has met its requested demand. Therefore, under this demand met condition state control logic 238 may generate a room damper control signal 228 such that each room damper 126 for the room(s) 202(1)-(3) having met demand for CO₂ is closed. If there are remaining rooms 202(1)-(3) that still demand CO₂, the control logic 238 may shift to the demand condition state, discussed above. If there are no remaining rooms 202(1)-(3) that still demand CO₂, the control logic 238 may shift to the exhaust condition state, discussed above.

Control logic 238 may operate based on an upset condition state. Under the upset condition state, sensor input 230 may indicate that a CO₂ level within a given room 202 is above, or below, a predefined threshold. For example, where regulation states the maximum CO₂ level allowed is 5,000 PPM, the threshold may be set at 5,000 PPM, or lower, such as 2,400 PPM. Therefore, under this upset condition state, control logic 238 may generate one or more of: a fresh air damper signal 218 to open fresh air damper 106; a damper control 220 signal such that mixing damper 118 is open; a relief damper control signal 222 such that relief air damper 112 is open; a blower control signal 224 such that blower 120 is on; a chilled water control signal 226 such that a valve coupled with chilled water coil 128 is closed; and a room damper control signal 228 such that each room damper 126(1)-(3) is closed; a siren control signal 232 such that sirens 208(1)-(3) in all rooms 202(1)-(3), or just the rooms 202(1)-(3) having sensor 210 levels above the threshold are activated; and an exhaust control signal 234 such that exhausts 212 in all rooms 202(1)-(3), or just the rooms 202(1)-(3) having sensor 210(1)-(3) levels above the threshold are opened. In embodiments, control logic 238 may also generate fire monitor output 236, which is sent to fire panel 214 for relay to a local fire department.

Control logic 238 may operate based on a power interruption state. Under the power interruption state, the power to sensors 210(1)-(3) may be interrupted, or otherwise, controller 204 may not be receiving sensor input 230 indicating a known or unknown error in the system. Therefore, under this power interruption state, control logic 238 may generate one or more of: a fresh air damper signal 218 to open fresh air damper 106; a damper control 220 signal such that mixing damper 118 is open; a relief damper control signal 222 such that relief air damper 112 is open; a blower control signal 224 such that blower 120 is on; a chilled water control signal 226 such that a valve coupled with chilled water coil 128 is closed; and a room damper control signal 228 such that each room damper 126(1)-(3) is closed.

Control logic 238 may further be based on additional sensors and/or signals generated within the system 100. For example, the demand condition state may not be entered until mixed air near water coil 128 is at a given temperature range, e.g., 70-80 degrees Fahrenheit. In other embodiments, the control logic may be via hysteresis, where the value of a physical property lags behind changes in the effect causing it, such that there is a dependence of the state of the system on its history.

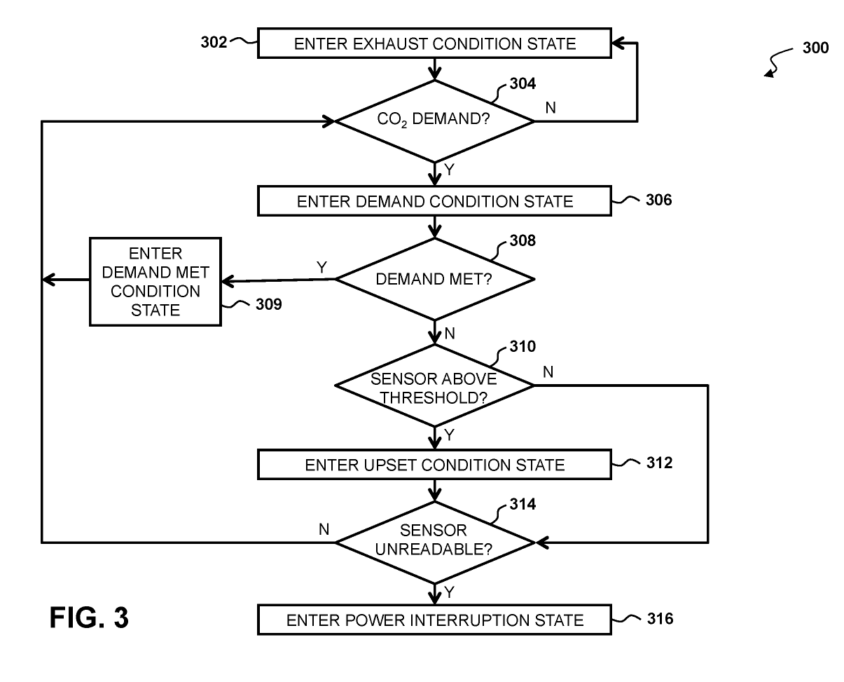

FIG. 3 depicts an example method 300 performed by control logic 238, of FIG. 2, in embodiments. Method 300 may begin at step 302 in an exhaust condition state. In one example of an operation of step 302, control logic is set to the exhaust condition state discussed above with respect to FIG. 2.

Step 304 is a decision. If method 300 determines that there is a CO₂ demand, then method 300 may proceed to step 306. Else, method 300 may repeat step 302. In one example of an operation of step 304, control logic analyzes sensor input from each room to determine if the sensed CO₂ levels are above, or below, a predetermined threshold.

In step 306, method 300 enters the demand condition state. In one example of step 306, control logic is set to the demand condition state discussed above with respect to FIG. 2.

Step 308 is a decision. If method 300 determines that the demanded CO₂ is met by the given room, then method 300 may enter a demand met condition state 309 and go back to step 304. Else, method 300 may proceed to step 310. In one example of an operation of step 308, control logic analyzes sensor input from each room to determine if the sensed CO₂ levels at the demand required by the given room.

Step 310 is a decision. If method 300 determines that the sensed CO₂ level is above a given threshold, then method 300 proceeds to step 312. Else, method 300 may proceed to step 314. In one example of an operation of step 310, control logic analyzes sensor input from each room to determine if the sensed CO₂ levels are above a given threshold, as discussed above with respect to FIG. 2.

In step 312, method 300 enters the upset condition state. In one example of step 312, control logic is set to the upset condition state discussed above with respect to FIG. 2.

Step 314 is a decision. If method 300 determines that a sensor is unresponsive, then method 300 proceeds to step 316. Else, method 300 may repeat step 304. In one example of an operation of step 314, control logic determines whether sensors 210 are providing sensor input 230 from each room 202

In step 316, method 300 enters the power interruption state. In one example of step 316, control logic is set to the power interruption state discussed above with respect to FIG. 2.

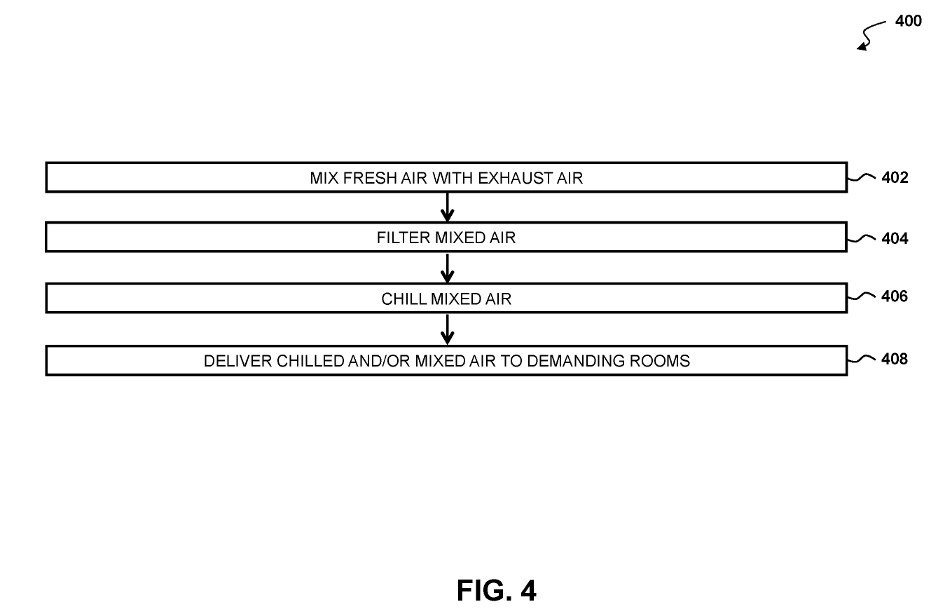

FIG. 4 depicts an example method 400 for delivering CO₂ to an indoor agriculture facility, in embodiments. Method 400 may be performed using system 100, discussed above with respect to FIGS. 1-3. Method 400 may be performed during the demand condition state 306 of FIG. 3 and discussed with respect to FIG. 2.

In step 402, method 400 mixes fresh air with exhaust air from a chiller. In one example of step 402, fresh air is mixed with exhaust from the exhaust pipe coupled with one or more chillers in the mixing chamber.

In step 404, method 400 may filter the mixed air from step 402. In one example of an operation of step 404, mixed air from mixing chamber is moved through the filter section using the blower within the blower section.

In step 406, method 400 may chill the mixed, and optionally filtered, air. In one example of step 406, mixed, and optionally filtered, air is chilled via chilled water coil to a given temperature range, e.g., 77-80 degrees, or some other range applicable to the given crop being grown in the indoor agriculture facility.

In step 408, method 400 delivers chilled and/or mixed air to demanding rooms. In one example of step 408, dampers are controlled to allow CO₂ to enter into the demanding room 202.

FIG. 5 illustrates a top-level functional block diagram of a computing device embodiment 500 of a system for distributing CO₂ into an indoor agriculture facility, in embodiments. The embodiment 500 is shown as a computing device 520 having a processor 524, such as a central processing unit (CPU), addressable memory 527, an external device interface 526, e.g., an optional universal serial bus port and related processing, and/or an Ethernet port and related processing, and an optional user interface 529, e.g., an array of status lights and one or more toggle switches, and/or a display, and/or a keyboard and/or a pointer-mouse system and/or a touch screen. Optionally, the addressable memory 527 may, for example, be: flash memory, eprom, and/or a disk drive or other hard drive. These elements may be in communication with one another via a data bus 528. The processor 524 may have an operating system 525 such as one supporting a web browser 523 and/or applications 522, which may be configured to execute steps of a process according to the example embodiments described herein.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A system comprising:
a fresh air damper configured to receive outside air via an input plenum;
a mixing chamber configured to receive the outside air from the fresh air damper and exhaust from one or more chillers, wherein the outside air and the exhaust are mixed in the mixing chamber;
a blower section comprising a blower, wherein the blower section is configured to receive mixed air from the mixing chamber, and wherein the mixed air from the mixing chamber is received through a mixing damper; and
a relief damper connected to at least one of: the mixing chamber and the blower section via a relief ducting, wherein the relief damper allows a release of at least one of: the fresh air, the exhaust, and the mixed air to an ambient environment.

2. The system of claim 1, wherein the exhaust is received in the mixing chamber via one or more exhaust connections.

3. The system of claim 1, wherein the mixed air from the mixing chamber is filtered through a filter.

4. The system of claim 1, further comprising:
a cooling section comprising a chilled water coil and an internal temperature sensor, wherein the cooling section is configured to receive mixed air from the blower section, and wherein the chilled water coil is configured to cool the mixed air to a set temperature as recorded by the internal temperature sensor.

5. The system of claim 4, further comprising:
a distribution ducting, wherein the distribution ducting is configured to receive at least one of: mixed air from the blower section and a chilled mixed air from the cooling section.

6. The system of claim 5, further comprising:
one or more room dampers, wherein the one or more room dampers are configured to receive a distributed air from the distribution ducting.

7. The system of claim 6, further comprising:
one or more distribution sections, wherein the one or more distribution sections are configured to receive the distributed air from the distribution ducting through the respective room damper.

8. The system of claim 7, further comprising:
one or more grow rooms, wherein the one or more grow rooms are configured to receive the distributed air from the respective distribution section.

9. The system of claim 8, further comprising:
one or more room exhausts, wherein the one or more room exhausts are configured to vent the distributed air to the ambient environment.

10. A system comprising:
a controller having a processor with addressable memory, the controller configured to:
enable an exhaust condition state, wherein in the exhaust condition state one or more chillers are operating and there is no demand for carbon dioxide in any grow room, and wherein enabling the exhaust condition state comprises generating at least one of:
a fresh air damper signal to open a fresh air damper;
a damper control signal to close a mixing damper;
a relief damper control signal to open a relief air damper;
a blower control signal to turn on a blower for at least a set time;
a chilled water control signal to close a chilled water coil valve; and
a room damper control signal to close each room damper.

11. The system of claim 10 wherein the controller is further configured to:
enable a demand condition state, wherein in the demand condition state the one or more chillers are operating and there is demand for carbon dioxide in at least one grow room, and wherein enabling the demand condition state comprises generating at least one of:
the fresh air damper signal to open the fresh air damper;
the damper control signal to open the mixing damper;
the relief damper control signal to close the relief air damper;
the blower control signal to turn on the blower;
the chilled water control signal to open the chilled water coil valve; and
the room damper control signal to open each room damper for each room demanding carbon dioxide.

12. The system of claim 11 wherein the controller is further configured to:
enable a demand met condition state, wherein in the demand met condition state, the at least one grow room with the demand for carbon dioxide has had the demand met, and wherein enabling the demand met condition state comprises generating at least one of:
the room damper control signal to close each room damper for each room having met demand for carbon dioxide;
the demand condition state if there are remaining rooms that demand carbon dioxide; and
the exhaust condition state if there are no remaining rooms that demand carbon dioxide.

13. The system of claim 10 wherein the controller is further configured to:
enable an upset condition state, wherein in the upset condition state at least one grow room has a carbon dioxide level that is at least one of: above a predefined threshold, and below a predefined threshold, and wherein enabling the upset condition state comprises generating at least one of:
the fresh air damper signal to open the fresh air damper;
the damper control signal to open the mixing damper;
the relief damper control signal to open the relief air damper;
the blower control signal to turn on the blower;
the chilled water control signal to close the chilled water coil valve;
the room damper control signal to close each room damper; and
an exhaust control signal to open at least one exhaust in at least one of:
all grow rooms, each grow room having the sensor level above the predefined threshold, and each grow room having the sensor level below the predefined threshold.

14. The system of claim 13 wherein enabling the upset condition state further comprises the controller generating:
a siren control to turn on at least one siren in at least one of: all grow rooms, each grow room having a sensor level above a predefined threshold, and each grow room having a sensor level below a predefined threshold.

15. The system of claim 13 wherein enabling the upset condition state further comprises the controller generating:
a fire monitor output, wherein the fire monitor output is sent to a fire panel for relay to a fire department.

16. The system of claim 10 wherein the controller is further configured to:
enable a power interruption state, wherein in the power interruption state comprises at least one of: a power to at least one sensor is interrupted and a sensor input is not received by the controller, and wherein enabling the power interruption state comprises:
the fresh air damper signal to open the fresh air damper;
the damper control signal to open the mixing damper;
the relief damper control signal to open the relief air damper;
the blower control signal to turn the blower on;
the chilled water control signal to close the chilled water coil valve; and
the room damper control signal to close each room damper.

17. A method comprising:
receiving, by a controller having a processor with addressable memory, at least one of: a temperature in a mixing chamber and a carbon dioxide concentration in a mixing chamber;
generating, by the controller, a damper control signal to open a mixing damper connected to the mixing chamber when at least one of: the received temperature in the mixing chamber is within a set temperature range and the received carbon dioxide concentration in the mixing chamber is within a set carbon dioxide range;
generating, by the controller, a blower control signal to turn on a blower, wherein the blower is configured to move air from the mixing chamber through one or more distribution ducts; and
generating, by the controller, a room damper control signal to open one or more room dampers, wherein the one or more room dampers control a flow of the air from the one or more distribution ducts to one or more grow rooms.

18. The method of claim 17, further comprising:
receiving, by the controller, a carbon dioxide concentration of each grow room of the one or more grow rooms;
generating, by the controller, the room damper control signal to close at least one of: all room dampers, each room damper for each grow room having the received carbon dioxide concentration above a predefined threshold, and each room damper for each grow room having the received carbon dioxide concentration below the predefined threshold; and
generating, by the controller, an exhaust control signal to open at least one exhaust in at least one of: all grow rooms, each grow room having the received carbon dioxide concentration above the predefined threshold, and each grow room having the received carbon dioxide concentration below the predefined threshold.

19. The method of claim 17, further comprising:
generating, by the controller, a fresh air damper control signal to at least one of: open a fresh air damper and close the fresh air damper, wherein the fresh air damper provides fresh air to the mixing chamber, and wherein the mixing chamber receives exhaust from one or more chillers.

20. The method of claim 17, further comprising:
generating, by the controller, a chilled water control signal to at least one of: open a chilled water coil valve and close the chilled water coil valve, wherein air from the blower travels past a chilled water coil receiving chilled water from the chilled water control valve prior to flowing to the one or more distribution ducts.
